(19) United States
(12) Patent Application Publication
(10) Pub. No.: US 2012/0109760 A1
(43) Pub. Date: May 3, 2012

(54) GUIDANCE APPARATUS, GUIDANCE METHOD, AND GUIDANCE PROGRAM

(75) Inventor: Hisashi KOISO, Tokyo-To (JP)

(73) Assignee: JVC KENWOOD Corporation a corporation of Japan, Yokohama-Shi (JP)

(21) Appl. No.: 13/283,008

(22) Filed: Oct. 27, 2011

(30) Foreign Application Priority Data
Oct. 29, 2010 (JP) 2010-244757

(51) Int. Cl. G06Q 50/12

(52) U.S. Cl. 705/15

(57) ABSTRACT

An orderer who has placed an order for goods is guided in accordance with a guidance program. Goods preparation-time information is stored that indicates goods for which an orderer has placed an order and a preparation time required for preparing the goods. A preparation complete time required for completing the preparation of the goods is derived by using the stored goods preparation-time information and using ordered goods information indicating the goods when the ordered goods information based on the order placement by the orderer is received. Guide information is generated for guiding the orderer based on the derived preparation complete time.

### CROSS-REFERENCE TO RELATED APPLICATIONS

This application is based on and claims the benefit of priority from the prior Japanese Patent Application No. 2010-244757 filed on Oct. 29, 2010, the entire content of which is incorporated herein by reference.

### BACKGROUND OF THE INVENTION

The present invention relates to a guidance apparatus, a guidance method, and a guidance program for guiding an orderer who has placed an order for goods.

With the advancement of ITS (Intelligent Transport System) technology, a payment system (a DSRC payment system) using DSRC (Dedicated Short Range Communication) has become widespread.

A DSRC payment system performs dedicated short Range communication between a in-vehicle apparatus (a DSRC in-vehicle apparatus) installed in a vehicle and for DSRC Communication, and a DSRC roadside unit installed along a road in front of an exit gate. While a vehicle of a user who has used a service provided by a store or the like is traveling on a road in front of an exit gate, a DSRC roadside unit installed along the road receives payment information including an in-vehicle apparatus ID, a credit card ID, etc. transmitted from a DSRC in-vehicle apparatus of the vehicle. When the payment information is confirmed, the DSRC roadside unit opens the exit gate so that the vehicle can pass therethrough without stop. In this way, the money payment for service use can be smoothly done.

Such a DSRC payment system has been used in a drive-through service in which users can buy goods such as first food while he or she is in a vehicle, hence expected to become widespread.

However, in a conventional drive-through service, order placement for goods by users is accepted in order of arrival of vehicles in a line at a goods order window in the premises of a store, then users accept ordered goods in order of arrival. Therefore, even if the preparation of goods ordered by a user (of a vehicle waiting in a line later) later than another user (of a vehicle waiting in a line earlier) is completed first, her or she has to wait until the preparation of goods ordered by the other user is completed, depending on goods to be ordered.

Accordingly, in such a conventional drive-through service, users cannot to be efficiently guided from the order placement for goods to the delivery of goods. Therefore, there is a problem in that the utility value of the DSRC payment system explained above is small if used in such a conventional drive-through service.

### SUMMARY OF THE INVENTION

A purpose of the present invention is to provide a guidance apparatus, a guidance method, and a guidance program for efficiently guiding a user from the order placement for goods to the delivery of goods.

The present invention provides a guidance apparatus comprising: a goods preparation-time information storing unit configured to store goods preparation-time information that indicates goods for which an orderer has placed an order and a preparation time required for preparing the goods; a preparation complete-time deriving unit for configured to derive a preparation complete time required for completing the preparation of the goods by using the stored goods preparation-time information and using ordered goods information indicating the goods when the preparation complete-time deriving unit receives the ordered goods information based on the order placement by the orderer; and a guiding unit configured to generate guide information for guiding the orderer based on the derived preparation complete time.

Moreover, the present invention provides a guidance method comprising the steps of: storing goods preparation-time information that indicates goods for which an orderer has placed an order and a preparation time required for preparing the goods; deriving a preparation complete time required for completing the preparation of the goods by using the stored goods preparation-time information and using ordered goods information indicating the goods when the ordered goods information ire received based on the order placement by the orderer; and generating guide information for guiding the orderer based on the derived preparation complete time.

Furthermore, the present invention provides a guidance program stored in a non-transitory computer readable device comprising: a program code of storing goods preparation-time information that indicates goods for which an orderer has placed an order and a preparation time required for preparing the goods; a program code of deriving a preparation complete time required for completing the preparation of the goods by using the stored goods preparation-time information and using ordered goods information indicating the goods when the ordered goods information is received based on the order placement by the orderer; and a program code of generating guide information for guiding the orderer based on the derived preparation complete time.

### BRIEF DESCRIPTION OF DRAWINGS

FIG. 1 is a view schematically showing a configuration of a guidance system according to an embodiment of the present invention;

FIG. 2 is a view showing a layout of the premises of a drive-through store according to the embodiment of the present invention;

FIG. 3 is a block diagram of a configuration of a store server apparatus according to the embodiment of the present invention;

FIG. 4 is a block diagram of a configuration of a DSRC in-vehicle apparatus according to the embodiment of the present invention;

FIG. 5 is a flow chart showing a guidance process performed by the store server according to the embodiment of the present invention;

FIG. 6 is a flow chart showing a preparation complete-time deriving process included in the guidance process of FIG. 5;

FIG. 7 is a flow chart showing a guide process included in the guidance process of FIG. 5;

FIG. 8 is view showing initial information displayed on a screen of a display unit of the DSRC in-vehicle apparatus according to the embodiment of the present invention;

FIG. 9 is view showing a structure of ordered-goods preparation time information pre-stored in a guidance apparatus according to the embodiment of the present invention;

FIG. 10 is view showing a structure of use information newly generated in response to the reception of select information from a drive-through user;

FIG. 11 is view showing a structure of use information after a preparation complete-time deriving process;

FIG. 12 is view showing preparation complete times derived in a chronological order and in order of acceptance of order placements; and

FIG. 13 is view showing preparation complete time information displayed on a screen of a display unit of the DSRC in-vehicle apparatus according to the embodiment of the present invention.

### DETAILED DESCRIPTION OF PREFERRED EMBODIMENTS

An embodiment of a guidance apparatus and a guidance system according the present invention will be explained with reference to the attached drawings. Described in the embodiment are a guidance apparatus and a guidance system for use in a drive-through system.

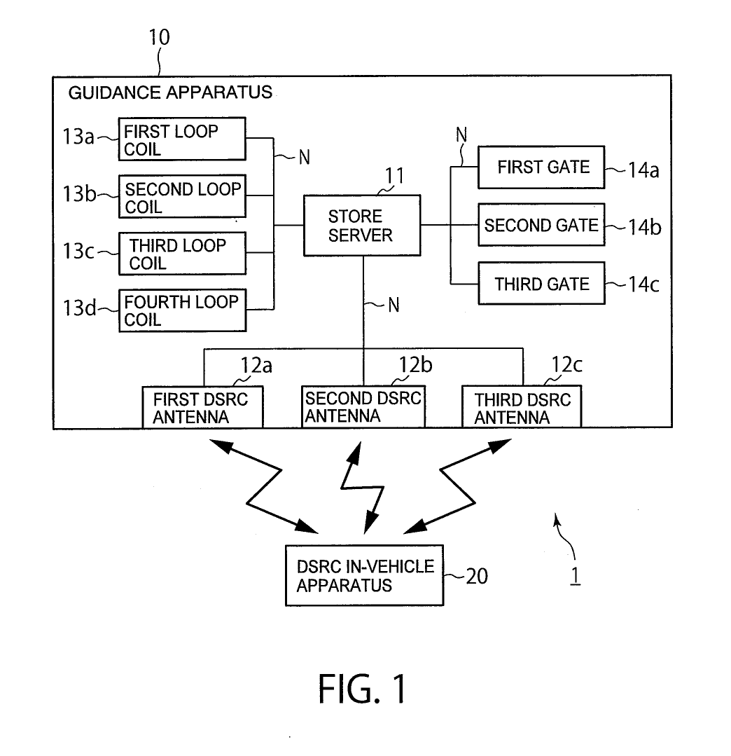

A configuration of a guidance system 1 is explained with reference to FIG. 1. The guidance system 1 is provided with a guidance apparatus 10 and an in-vehicle apparatus (a DSRC in-vehicle apparatus) 20 having a DSRC (Dedicated Short Range Communication) function. In the guidance system 1, the guidance apparatus 10 performs various types of communications with the DSRC in-vehicle apparatus 20 to guide a driver (a drive-through user) of a vehicle C1 equipped with the apparatus 20 to a goods delivery window in a store S.

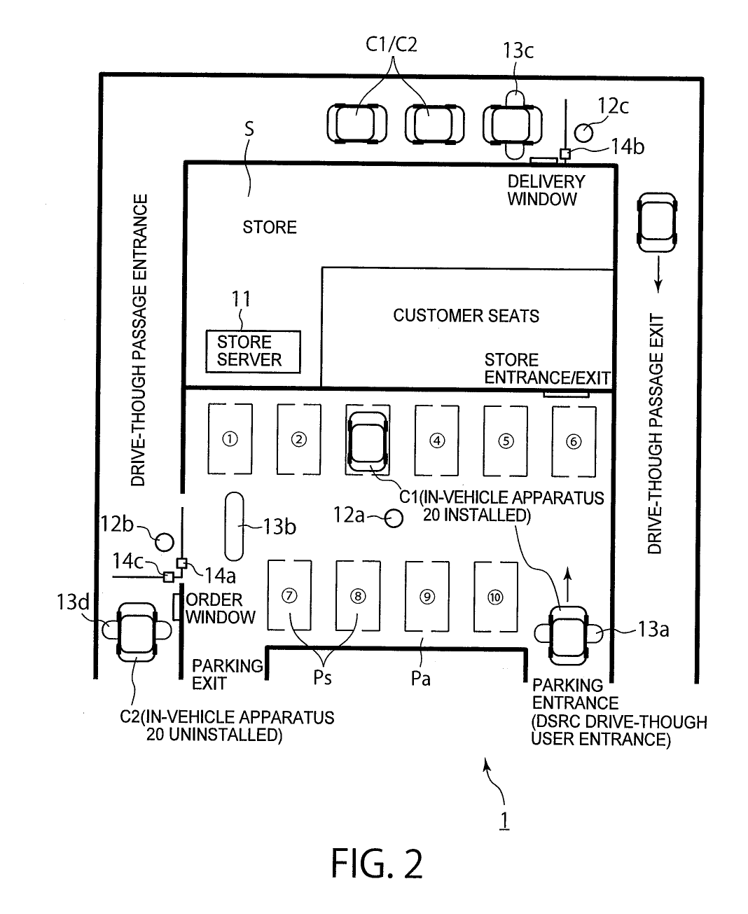

In detail, as shown in FIG. 2, suppose that a vehicle that enters the premises of the store S through the entrance of a parking lot Pa is a vehicle C1 equipped with the DSRC in-vehicle apparatus 20. In this case, the guidance apparatus 10 communicates with the in-vehicle apparatus 20 in various radio communication bands, such as ISM (Industry-Science-Medical) band at 5.8 GHz, to provide a menu of goods sold at the store S and accepts an order for goods from a drive-through user (a driver) of the vehicle C1.

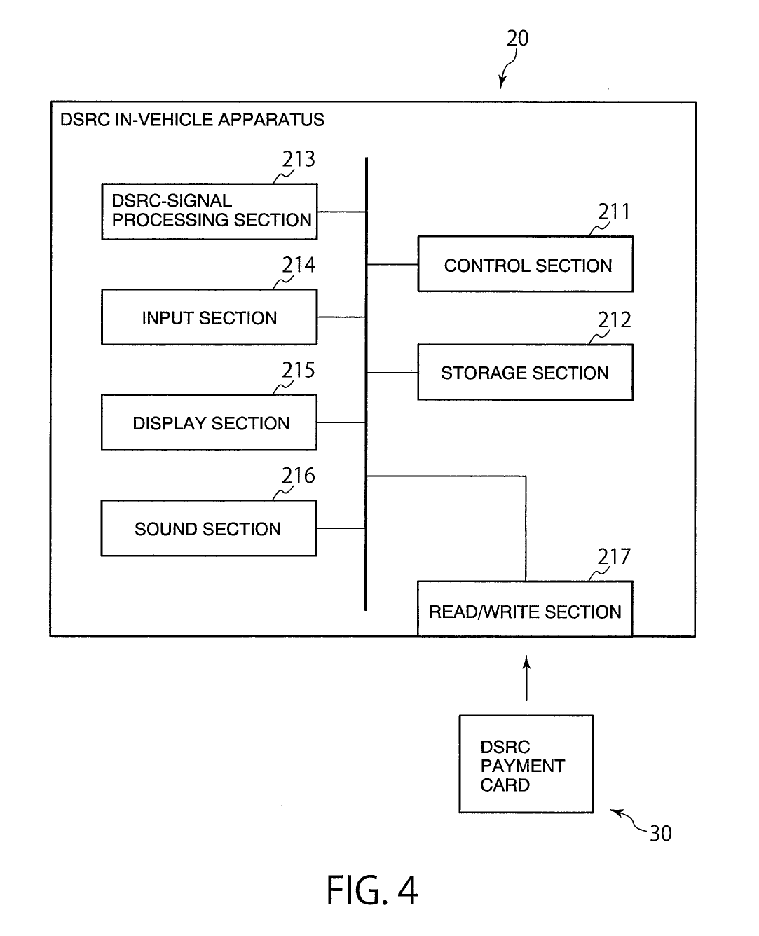

With this system, the drive-through user can select goods on a goods menu displayed on a screen (on a display section 215 in FIG. 4) of the in-vehicle apparatus 20 and place an order for the goods while parking the vehicle C1 in a parking space Ps. Accordingly, the drive-through user of the vehicle C1 equipped with the DSRC in-vehicle apparatus 20 dose not form a line with other vehicles in front of an order window and select goods in a hurry with care about the following vehicle. Moreover, a clerk of the store S do not need to accept an order for goods from the drive-through user of the vehicle C1 equipped with the DSRC in-vehicle apparatus 20, hence the store clerk can do other works, resulting in higher efficiency of working at the store S.

The guidance apparatus 10 accepts an order for goods from each of drive-through users of a plurality of vehicles C1 equipped with the DSRC in-vehicle apparatus 20, in the parking lot Pa. Based on the contents of each order, the guidance apparatus 10 derives a preparation completion time for each ordered goods. Then, the guidance apparatus 10 guides the vehicles C1 of the drive-through users to a goods delivery window in order of the preparation completion time elapsed earlier. Suppose that a first drive-through user of a first vehicle C1 has placed an order for goods before a second drive-through user of a second vehicle C1. In this case, if the preparation of goods ordered by the second drive-through user can be completed before that for the first drive-through user, the guidance apparatus 10 can guide the second vehicle C1 to the goods delivery window before the first vehicle C1. Accordingly, high efficiency is achieved for a guide process for vehicles from the acceptance of an order for goods to the delivery of the goods to drive-through users.

As shown in FIG. 1, the guidance apparatus 10 is provided with a store server 11, a first to a third DSRC antenna 12a to 12c, a first to a fourth loop coil 13a to 13d, and a first to a third gate 14a to 14c. These components of the guidance apparatus 10 are arranged in the store S and its premises, as shown in FIG. 2.

The store server 11 is connected to the first to third DSRC antennas 12a to 12c, the first to fourth loop coils 13a to 13d, and the first to third gates 14a to 14c via a network N for control of these components. The network N may be LAN (Local Area Network), the Internet, a dedicated network, a circuit switching network, and a packet switching network. Moreover, the network N may be a wired or wireless network.

The store server 11 communicates with the in-vehicle apparatus 20 in various radio communication bands, such as ISM (Industry-Science-Medical) band at 5.8 GHz, via the first to third DSRC antennas 12a to 12c.

The first DSRC antenna 12a is a communications unit installed in the parking lot Pa of the store S, for radio communications with the DSRC in-vehicle apparatus 20 of a vehicle C1 parked in the parking lot Pa. The second DSRC antenna 12b is a communications unit installed near a drive-through passage entrance of the store S, for radio communications with the DSRC in-vehicle apparatus 20 of a vehicle C1 guided in front of the drive-through passage entrance. The third DSRC antenna 12c is a communications unit installed at the goods delivery window (near a drive-through passage exit) of the store S, for radio communications with the DSRC in-vehicle apparatus 20 of a vehicle C1 guided to the goods delivery window.

The first to fourth loop coils 13a to 13d detect a vehicle based on the change in inductance of a coil due to the approach of the vehicle, generate a vehicle detection signal in accordance with the detection of the vehicle, and supplies the signal to the store server 11. The store server 11 determines the existence of a vehicle when it receives the vehicle detection signal from any of the first to fourth loop coils 13a to 13d.

The first loop coil 13a is embedded in the entrance of the parking lot Pa of the store S, to detect a vehicle entering through the entrance of the parking lot Pa. The second loop coil 13b is embedded in front of the drive-through passage entrance of the store S, to detect a vehicle located in front of the drive-through passage entrance. The third loop coil 13c is embedded in front of the goods delivery window (near the drive-through passage exit) of the store S, to detect a vehicle located in front of the goods delivery window. The fourth loop coil 13d is embedded near an order window of the store S, for vehicles C2 without equipped with the DSRC in-vehicle apparatus 20, to detect a vehicle located near the order window.

The first to third gates 14a to 14c are provided with a pole for restricting the entrance or exit of vehicles and a motor for raising or lowering the pole, and so on. The first to third gates 14a to 14c are controlled so that the pole is initially lowered to close the gate and raised to open the gate in response to a drive signal supplied from the store server 11.

The first gate 14a is located in front of the drive-through passage entrance of the store S. The second gate 14b is located in front of the goods delivery window (near the drive-through passage exit) of the store S. The third gate 14c is located near the order window of the store S, for the vehicles C2 without equipped with the DSRC in-vehicle apparatus 20.

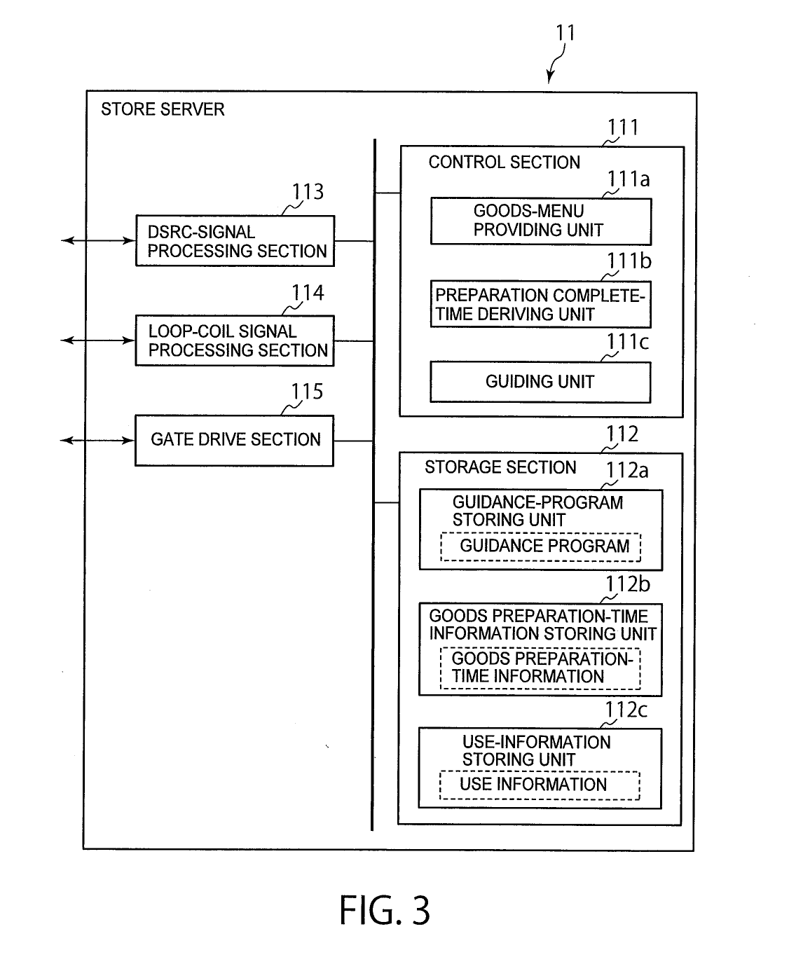

Described next is the internal configuration of the store server 11. As shown in FIG. 3, the store server 11 is provided with a control section 111, a storing section 112, a DSRC-signal processing section 113, a loop-coil signal processing section 114, and a gate drive section 115.

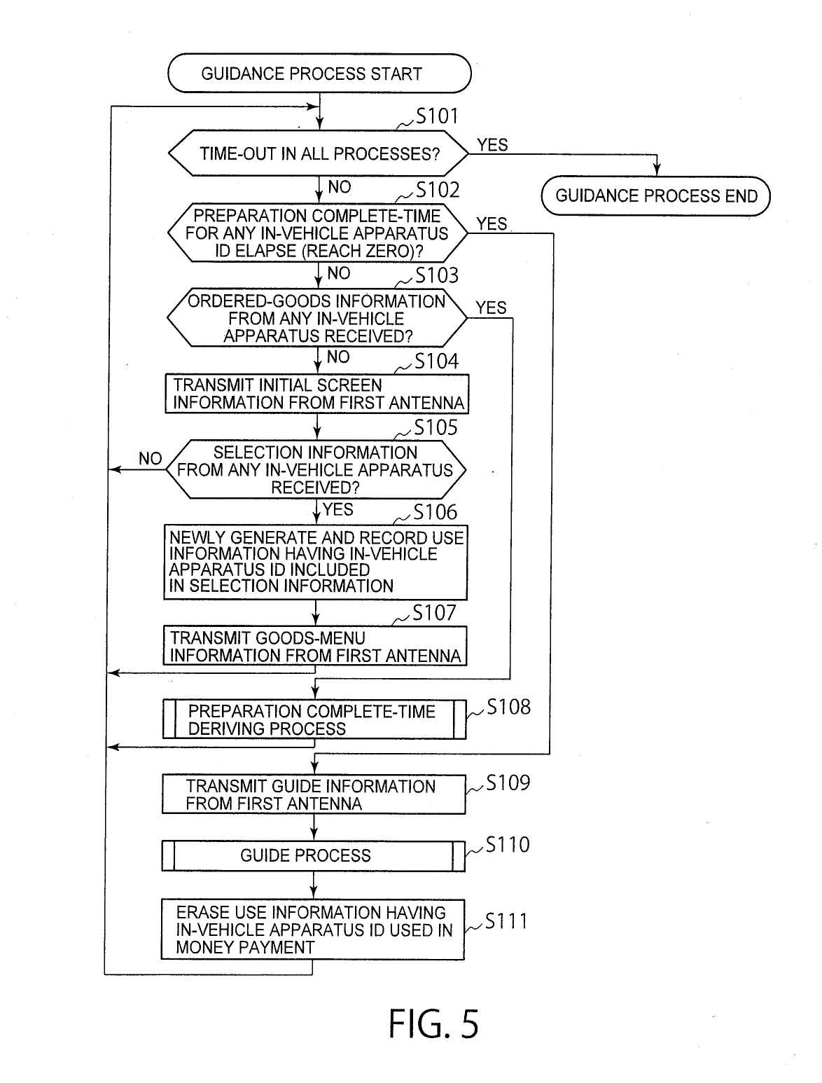

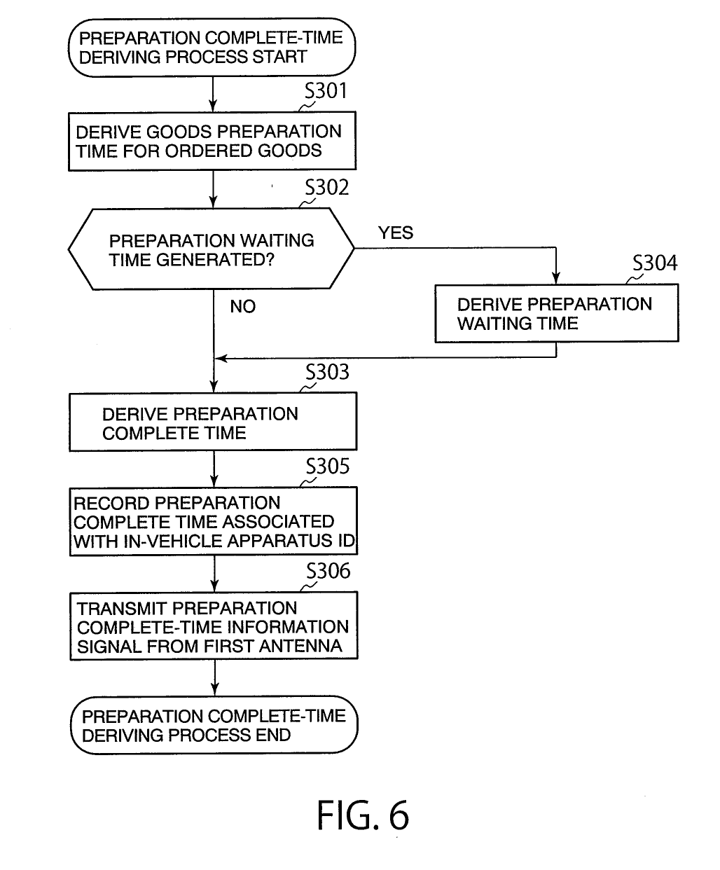

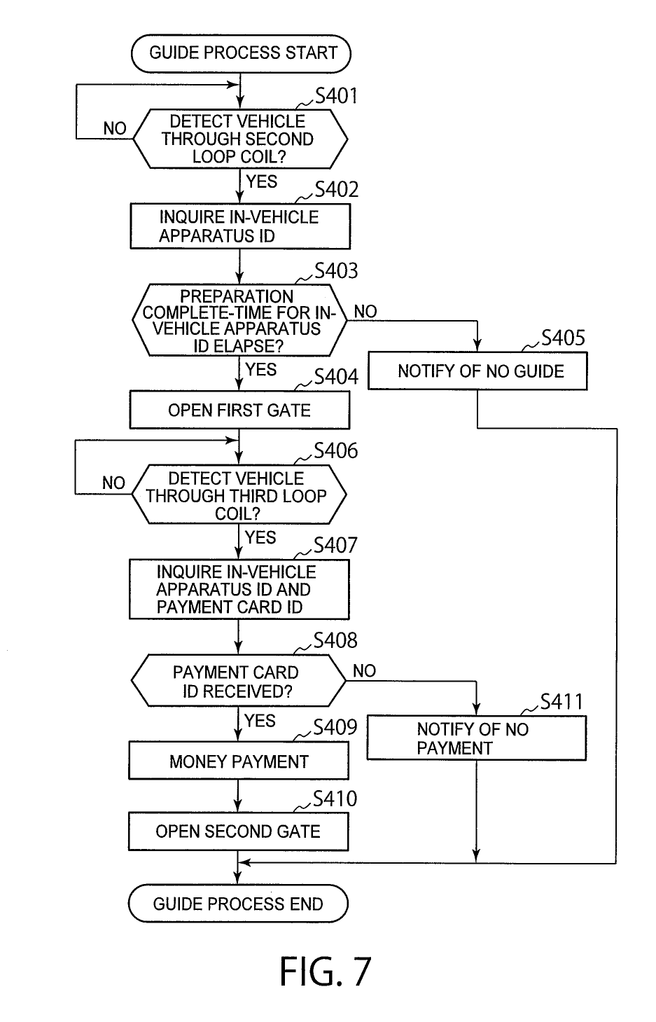

The control section 111 includes a CPU (Central Processing Unit) and a RAM (Random Access Memory). The CPU uses the RAM as a work area for control of each component of and the total control of the store server 11. The control section 111 executes a guidance program (which will be describe later) stored in the storing section 112, to function as a goods-menu providing unit 111a, a preparation complete-time deriving unit 111b, and a guiding unit 111c. The goods-menu providing unit 111a, the preparation complete-time deriving unit 111b, and the guiding unit 111c perform a guidance process shown in FIG. 5 (including a preparation complete-time deriving process in FIG. 6 and a guide process in FIG. 7).

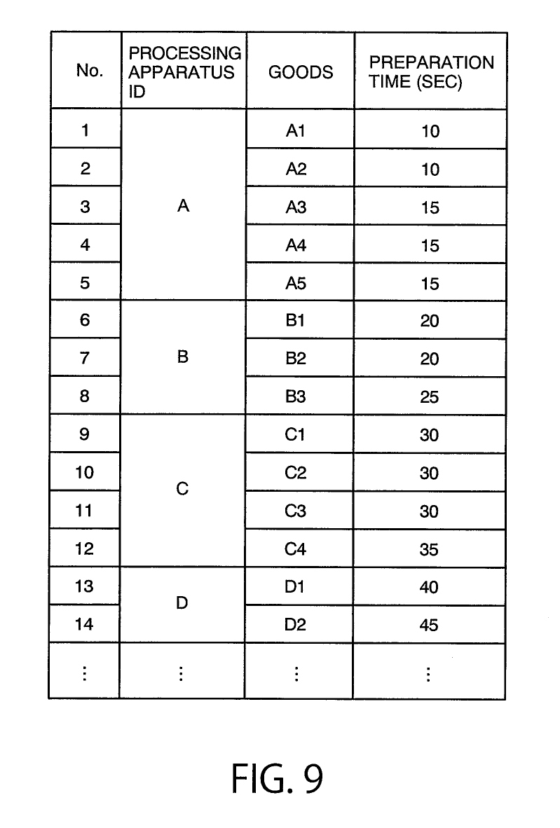

The storing section 112 includes a hard disk, a flash memory, etc. to store an OS (Operating System), various application programs, and various types of data or information. The storing section 112 stores various types of data or information generated through a guidance process which will be explained later, under control by the control section 111. As shown in FIG. 3, the storing section 112 has a guidance-program storing unit 112a, a goods preparation-time information storing unit 112b, and a use-information storing unit 112c. The guidance-program storing unit 112a has pre-stored a guidance program used for executing a guidance process which will be explained later. The goods preparation-time information storing unit 112b has pre-stored goods preparation-time information that indicates goods sold at the store S and the corresponding preparation time for preparing the goods, as shown in FIG. 9. The use-information storing unit 112c stores use information that indicates the status of use of drive-through, generated for each drive-through user (in-vehicle apparatus ID) who has selected the use of drive-through in the guidance process which will be explained later.

The DSRC-signal processing section 113 is a communications processor employing a DRSC system and includes an amplifier, a modulator, a demodulator, etc. The DSRC-signal processing section 113 performs amplification, demodulation, etc. to the signals (radio signals) that indicate various information and are received by the first to third DSRC antenna 12a to 12c. Moreover, the DSRC-signal processing section 113 performs modulation and other processing to the signals that indicate various information and are transmitted from the first to third DSRC antenna 12a to 12c.

The loop-coil signal processing section 114 includes an A/D converter and other circuitry. The loop-coil signal processing section 114 performs A/D conversion or the like to convert analog vehicle detection signals supplied from the first to fourth loop coils 13a to 13d into digital vehicle detection signals. The digital vehicle detection signals are supplied to the control section 111 which then supplies a control signal to the gate drive section 115.

The gate drive section 115 supplies a drive signal to any of the first to third gates 14a to 14c (FIG. 2) in response to the control signal from the control section 111 to raise or lower the pole of the gate that receives the drive signal to open or close the gate.

Described next is the internal configuration of the DSRC in-vehicle apparatus 20. As shown in FIG. 4, the DSRC in-vehicle apparatus 20 is provided with a control section 211, a storing section 212, a DSRC-signal processing section 213, an input section 214, a display section 215, a sound section 216, and a read/write section 217.

The control section 211 includes a CPU and a RAM. The CPU uses the RAM as a work area for control of each component of and the total control of the DSRC in-vehicle apparatus 20. The storing section 212 includes a hard disk, a flash memory, etc. to store an OS, various application programs, various types of data or information to be used for various processes. The storing section 212 has pre-stored in-vehicle apparatus ID that is used in the guidance process described later for uniquely identifying the DSRC in-vehicle apparatus 20. Moreover, the storing section 212 temporarily stores various information that are received in the guidance process, under control by the control section 211.

The DSRC-signal processing section 213 performs various types of radio communications (for example, two-way radio communications in a 5.8-GHz ISM band) with the first to third DSRC antennas 12a to 12c. The DSRC-signal processing section 213 is a communications processor including an amplifier, a modulator, a demodulator, and a transmitting and receiving antenna, etc. The DSRC-signal processing section 213 performs amplification, demodulation, etc. to the signals (radio signals) that indicate various information and are received via the transmitting and receiving antenna. Moreover, the DSRC-signal processing section 213 performs modulation and other processing to the signals that indicate various information supplied from the control section 211 and transmitted via the transmitting and receiving antenna.

The input section 214 includes various operation keys, such as a menu key and an enter key. The input section 214 accepts an input operation of a driver (a drive-through user) who uses the DSRC in-vehicle apparatus 20 and supplies an operation signal corresponding to the input operation to the control section 211.

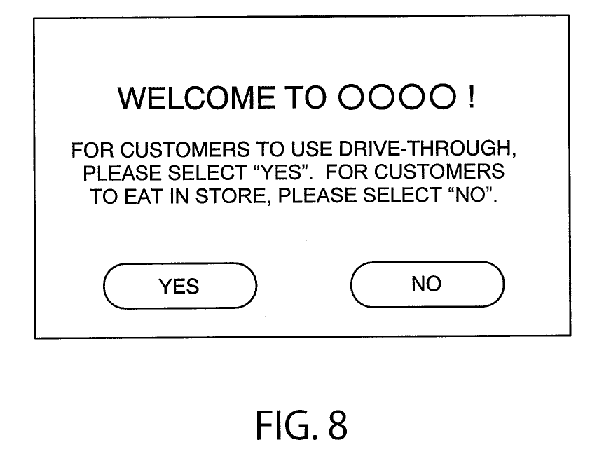

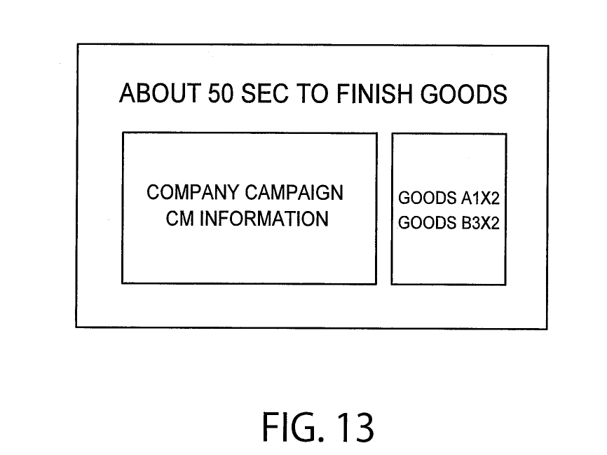

The display section 215 includes a liquid crystal display. Displayed on the screen of the display section 215 are various images and windows based on various image and window data supplied from the control section 211. For example, as shown in FIG. 13, displayed on the screen of the display unit 215 in the guidance process are: a drive-through selection window for selection of drive-through use or not, as shown in FIG. 8; and a status window for showing the elapse of a preparation complete time for completion of goods ordered by a drive-through user.

The input section 214 and the display section 215 may be equipped with a touch panel. The touch panel displays an operation window via which various operations are accepted and generates an operation signal that corresponds to the location on the panel on which a drive-through user performs a touch operation. The generated operation signal is supplied to the control section 211.

The sound section 216 includes a D/A converter, a speaker, etc. The sound section 216 performs signal processing such as D/A conversion to convert a digital audio signal for sound production supplied from the control section 211 into an analog audio signal and outputs various audio messages via the speaker. For example, under control by the control section 211, the sound section 216 outputs audio messages, such as “Please select goods from a goods menu for order placement.”, “It will take XX seconds to complete the preparation of the ordered goods.”, and “Preparation of the ordered goods complete. Please move to the first gate.” for guiding a vehicle of a drive-through user.

The read/write section 217 includes an IC card reader/writer equipped with an IC card slot. Inserted into the IC card slot is, for example, a DSRC payment card 30 on which a credit card ID of a drive-through user has been electronically written. When the DSRC payment card 30 is inserted into the IC card slot, under control by the control section 211, the read/write section 217 retrieves information such as credit card ID of a drive-through user and supplies the information to the control section 211. Then, the control section 211 uses the information such as a credit card ID received from the read/write section 217, for a payment process after a user receives ordered goods.

An operation of the guidance system 1 configured as described above will be explained with respect to FIG. 5. A driver of a vehicle C1 equipped with the DSRC in-vehicle apparatus 20 can use a DSRC-compatible drive-through service provided by the guidance system 1. A driver of a vehicle C1 equipped with the DSRC in-vehicle apparatus 20 moves the vehicle C1 to the store S through the entrance of the parking lot Pa to use the drive-through service. On the other hand, a driver of a vehicle C2 without the DSRC in-vehicle apparatus 20 cannot use the DSRC-compatible drive-through service, hence uses a conventional service. The vehicles to enter into the parking lot Pa of the store S are, not only vehicles C1 for using the DSRC-compatible drive-through service, but also vehicles of drivers having a purpose of eating and drinking in the store S.

In the guidance apparatus 10 installed in the premises of the store S, the first loop coil 13a embedded at the entrance of the parking lot Pa detects a vehicle and supplies a vehicle detection signal to the store server 11. When the control section 111 of the store server 11 receives the vehicle detection signal from the first loop coil 13a via the loop-coil signal processing section 114, it determines that a vehicle has entered the premises of the store S through the entrance of the parking lot Pa. When the control section 111 determines that a vehicle has entered the premises of the store S, and if the guidance program stored in the guidance-program storing section 112a has not been executed, it executes the program to start the guidance process described below. For example, suppose that a vehicle enters the premises of the store S through the entrance of the parking lot Pa, as shown in FIG. 2, when the control section 111 has not executed the guidance program stored in the guidance-program storing section 112a. The first loop coil 13a detects the vehicle, and in response to that, the control section 111 starts the guidance process. After the guidance process starts, not only the vehicle that has entered the premises of the store S at first, but also other vehicles that enter the premises of the store S through the entrance of the parking lot Pa are subjected to the guidance process. In the guidance process, the control section 111 functions as the goods-menu providing unit 111a, the preparation complete-time deriving unit 111b, and the guiding unit 111c, to perform the respective processes.

The goods-menu providing unit 111a determines whether all processes in a waiting mode have been running out of time (time out) among the various processes executed by the guidance process program (step S101). If all processes in a waiting mode have not been running out of time (No in step S101), the goods-menu providing unit 111a moves to step S102, however, if all processes in a waiting mode have been running out of time (Yes in step S101), ends the guidance process. The goods menu providing unit 111a may automatically remove step S101, just after the start of the guidance process, until step S104 (which will be described later) in which a waiting mode occurs is executed.

In step S102, the guiding unit 111c determines whether any of preparation complete times has elapsed which are derived and stored one by one in step S108 (which will be described later) based on ordered goods information received from a driver of each vehicle C1 has elapsed. If any of preparation complete times has elapsed (Yes in step S102), the guiding unit 111c moves to step S108, however, if not (No in step S102), moves to step S103. Just after the start of the guidance process, step S107 is not executed and hence the guiding unit 111c moves to step S102. Therefore, the guiding unit 111c may automatically remove step S102 until step S107 is executed.

In step S103, the preparation complete-time deriving unit 111b determines whether to have received ordered goods information (whether to have received a signal carrying the ordered goods information) from any DSRC in-vehicle apparatus 20. Step S103 is executed after transmitting a goods-menu information signal to a drive-through user (a driver) of a vehicle C1 who selects the use of drive-through in step S107 (which will be describe later). If the preparation complete-time deriving unit 111b determines that it has received ordered goods information from any DSRC in-vehicle apparatus 20 (Yes in step S103), it moves to step S108, however, if not (No in step S103), it moves to step S104. Just after the start of the guidance process, step S106 is not executed and hence the preparation complete-time deriving unit 111b moves to step S104. Therefore, the complete-time deriving unit 111b may automatically remove step S103 after the start of the guidance process until step S106 is executed.

In step S104, the goods-menu providing unit 111a generates initial screen (window) information for inquiring whether a driver of a vehicle that has entered the parking lot Pa uses drive-through and transmits an initial-screen information signal carrying the initial screen information from the first DSRC antenna via the DSRC-signal processing section 113 (step S104). The initial screen information generated by the goods-menu providing unit 111a includes status information that indicates step-by-step guidance on drive-through use. The status information included in the initial screen information involves information on initial guidance. Then, a vehicle C1 equipped with the DSRC in-vehicle apparatus 20 among the vehicles that have entered the parking lot Pa receives, at the DSRC in-vehicle apparatus 20, the initial-screen information signal transmitted from the first DSRC antenna 12a. The DSRC in-vehicle apparatus 20 determines that the received initial-screen information signal indicates the initial guidance on the DSRC drive-through based on the status information included in the initial-screen information.

The DSRC-signal processing section 213 of the DSRC in-vehicle apparatus 20 receives the initial-screen information signal transmitted from the first DSRC antenna 12a and supplies the initial-screen information carried by the initial-screen information signal to the control section 211. The control section 211 controls the display unit 215 to display the received initial screen information on its screen. Displayed on the screen of the display unit 215 is, for example, a message “Welcome to O O O O!” together with a message for drivers to select whether to use drive-through. The initial screen information may include sound information that includes, for example, the same contents as those displayed on the screen of the display unit 215 and is output from the sound section 216. There is a case where the DSRC in-vehicle apparatus 20 has already received the initial-screen information signal and receives again the initial-screen information signal from the first DSRC antenna 12a. In this case, the DSRC in-vehicle apparatus 20 determines that it has already received the initial screen information based on the status information included in the already-received initial screen information, and hence does not display an initial screen and abandons the initial screen information.

The driver of the vehicle C1 confirms the initial screen information displayed on the screen of the display unit 215 and selects whether to use drive-through via the input section 215. With these operations, the driver himself or herself notifies of whether to use the DSRC-compatible drive-through service. In response to the operations by the driver at the input section 215, the control section 211 of the DSRC in-vehicle apparatus 20 generates select information that indicates whether the driver has selected the drive-through use. When generating the select information, the control section 211 retrieves in-vehicle apparatus ID, the information for uniquely identifying the DSRC in-vehicle apparatus 20, from the storing section 212 and includes the in-vehicle apparatus ID and the status information (information indicating the initial guidance) described above in the select information. Then, the control section 211 controls the DSRC-signal processing section 213 to transmit a select-information signal carrying the select information.

The goods-menu providing unit 111a receives the select information carried by the select-information signal transmitted from the DSRC-signal processing section 213 of the DSRC in-vehicle apparatus 20, via the first DSRC antenna 12a, and determines whether the received select information indicates the selection of drive-through use (step S105 in FIG. 5). Only if it is determined that the received select information indicates the selection of drive-through use (Yes in step S105), the goods-menu providing unit 111a moves to step S106, however, if not (No in step S105) or in another case including not receiving the select information, returns to step S101 to perform the process described above.

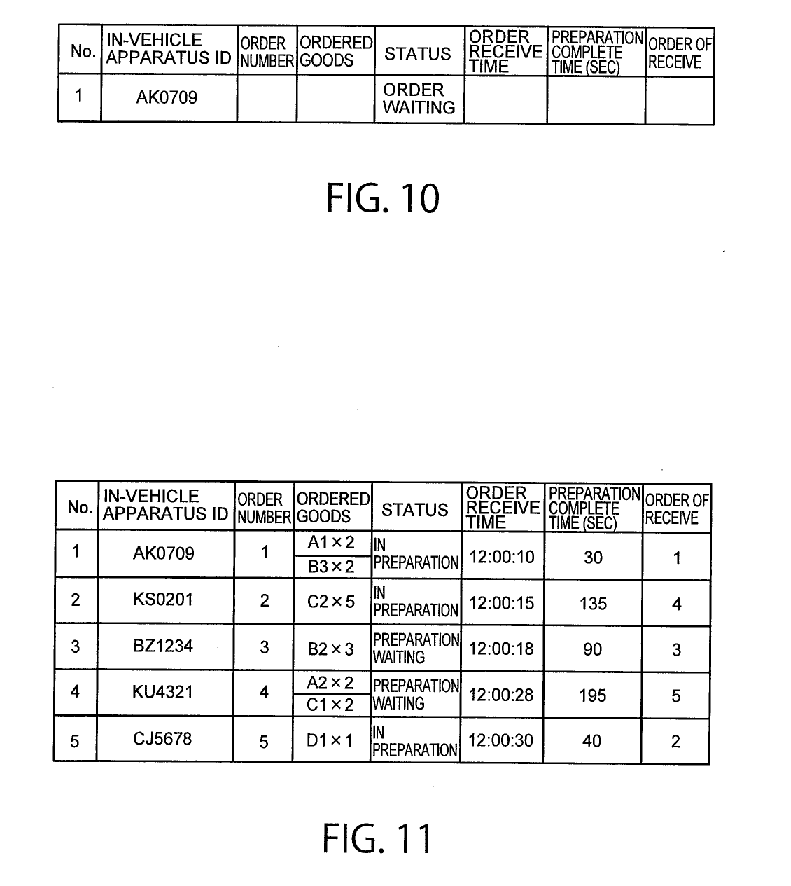

In step S106, the goods-menu providing unit 111a extracts the in-vehicle apparatus ID from the received select information, for use in the communication described below, as information to identify the DSRC in-vehicle apparatus 20 as a communication partner; generates new use information that indicates use status of drive-through by using the extracted in-vehicle apparatus ID; and additionally records the new use information in the use information storing unit 112c. When extracting the in-vehicle apparatus ID, the goods-menu providing unit 111a generates new use information, for example, as shown in FIG. 10, including items such as an order number, ordered goods, status (use status), an order receive time, a preparation complete time, and an order of receive, as associated with the in-vehicle apparatus ID and in addition to the item of the in-vehicle apparatus ID. After generating the items of the new use information, the goods-menu providing unit 111a stores data only for the items of the in-vehicle apparatus ID and the status (order waiting), as shown in FIG. 10.

After generating and recording the new use information, the goods-menu providing unit 111a generates goods menu information that indicates a menu of various goods sold at the store S. The goods menu information includes the in-vehicle apparatus ID extracted in step S105 and the associated status information (with indication of order waiting, as shown in FIG. 10). The goods-menu providing unit 111a controls the DSRC-signal processing section 113 to transmit a goods-menu information signal carrying the goods menu information from the first DSRC antenna 12a (step S107). Then, the goods-menu providing unit 111a returns to step S101 to perform the process described above.

The goods-menu information signal transmitted from the first DSRC antenna 12a is received only by the DSRC in-vehicle apparatus 20 (received at the DSRC-signal processing section 213) having the same in-vehicle apparatus ID as the in-vehicle apparatus ID included in the goods menu information carried by the goods-menu information signal. In other words, the DSRC in-vehicle apparatus 20 that has transmitted the select-information signal described above receives the goods-menu information signal carrying its in-vehicle apparatus ID. In the DSRC in-vehicle apparatus 20, the control section 211 receives the goods menu information carried by the goods-menu information signal from the DSRC-signal processing section 213 and controls the display section 215 to display the goods menu information on its screen. Displayed on the screen of the display section 215 is an image or a widow for selection of goods to be ordered from the menu of goods sold at the store S. The goods menu information may include a sound message, for example, for explaining the name of goods, calorie information, and allergy information, which is output from the sound section 216.

A drive-through user (a driver of the vehicle C1) confirms the goods menu information displayed on the screen of the display section 215 and operates the input section 214 to select and determine the goods to be ordered from the goods menu information, thus placing an order for goods. In response to the operation by the drive-through user at the input section 214, the control section 211 generates ordered goods information (indicating the name of goods, the number of the goods, etc.) that indicates the goods ordered by the drive-through user. The ordered goods information includes the in-vehicle apparatus ID of the DSRC in-vehicle apparatus 20 and the status information (with indication of preparation waiting, as shown in FIG. 10). Then, the control section 211 controls the DSRC-signal processing section 213 to transmit an ordered-goods information signal that carries the generated ordered goods information.

In the store server 11, the DSRC-signal processing section 113 receives, via the first antenna 12a, the ordered-goods information signal carrying the generated ordered goods information and transmitted from the DSRC in-vehicle apparatus 20. The preparation complete-time deriving unit 111b of the control section 111 receives the ordered-goods information signal carrying the generated ordered goods information from the DSRC-signal processing section 113, thereby accepting the order by the drive-through user (an orderer). Then, the preparation complete-time deriving unit 111b determines that it has accepted ordered goods information from any DSRC in-vehicle apparatus 20 (Yes in step S103 of FIG. 5) and moves to step S108. In step S108, the preparation complete-time deriving unit 111b performs a preparation complete-time deriving process for deriving the time (a preparation complete time) required for completing the preparation of ordered goods indicated by the ordered goods information.

The preparation complete-time deriving unit 111b stores several data in the items of order number, ordered goods, and order receive time corresponding to the same in-vehicle apparatus ID as the in-vehicle apparatus ID included in the received ordered goods information, among various use information stored in the use-information storing unit 112c and updates the status information. For example, as shown in No. 1 of FIG. 11, when accepting ordered goods information at first after starting the guidance process, the preparation complete-time deriving unit 111b records “1”, “goods A1×2 and goods B3×2”, and “12:00:10” in the items of order number, ordered goods, and order receive time, respectively, that correspond to the same in-vehicle apparatus ID as the in-vehicle apparatus ID “AK0709” included in the ordered goods information, and updates the status information from “order waiting” to “ in preparation (or preparation waiting).

As described above the guidance apparatus 10 (the goods-menu providing unit 111a of the store server 11) performs various processes for accepting an order for goods by a drive-through user of each vehicle C1 equipped with DSRC in-vehicle apparatus 20 that has entered the parking lot Pa of the store S.

Drive-through users can select goods and place an order while parking the vehicles C1 in empty parking spaces Ps, with no necessary to do it in order of entrance to the parking lot Pa, in FIG. 2. Accordingly, the drive-through users of the vehicles C1 equipped with the DSRC in-vehicle apparatus 20 do not need to form a line with other vehicles in front of the order window provided along the drive-through passage and select goods in a hurry with care about the following vehicle. Moreover, a clerk of the store S do not need to accept an order for goods from the drive-through users of the vehicles C1 equipped with the DSRC in-vehicle apparatus 20, hence the store clerk can do other works, resulting in higher efficiency of working at the store S.

Described next with respect to FIG. 6 is a preparation complete-time deriving process performed by the preparation complete-time deriving unit 111b of the store server 11.

When receiving the ordered goods information, the preparation complete-time deriving unit 111b uses the goods information to look up the list of ordered-goods preparation time shown in FIG. 9 and stored in the goods preparation-time information storing section 112b to derive an ordered-goods preparation time required for preparing each goods (step S301). Suppose that ordered goods indicated by the ordered goods information that has been received by the goods-menu providing unit 111a are goods A1×2 and goods B3×2. In this case, the preparation complete-time deriving unit 111b looks up the goods preparation-time information (FIG. 9) and multiplies a preparation time (10 seconds) for the ordered goods A1 by the number (two in this case) of the ordered goods A1 to obtain a goods preparation time (20 seconds). In the same way, the preparation complete-time deriving unit 111b multiplies a preparation time (25 seconds) for the ordered goods B3 by the number (two in this case) of the ordered goods B3 to obtain a goods preparation time (50 seconds).

Next, the preparation complete-time deriving unit 111b determines whether a preparation waiting time is generated for the ordered goods (step S302). It is the basic principle that the preparation of ordered goods is quickly done when the order is placed. However, it could happen that the preparation cannot be quickly done, depending on goods. For example, if a processing apparatus for preparation of goods (such as a cooker) has been used for the goods for which an order has been placed before, it cannot be used for the goods for which an order is placed now, hence a preparation waiting time is generated.

A condition for a processing apparatus being not be used is, for example, that the same type of goods as that ordered now has been ordered before. The preparation waiting time that is generated when the condition is met is calculated based on an elapsed time of the preparation waiting time for the goods ordered before. Another condition for a processing apparatus being not be used is, for example, that the number of the same type of goods as the goods ordered now and that has been ordered before reaches a threshold level set as the number of same goods processable by the processing apparatus. The preparation waiting time that is generated when the condition is met is calculated based on an elapsed time of the total goods preparation time for the goods ordered before until the number of same goods ordered before reaches a specific number. Defined in the guidance program are the condition for a processing apparatus being not be used and a method for calculating a preparation waiting time that is generated when the condition is met. In this embodiment, the status in which the same type of goods as that ordered now has been ordered before is set as the condition for a processing apparatus being not be used. If this condition is met, a preparation waiting time is calculated based on an elapsed time of the preparation waiting time for the goods ordered before. The condition and calculation method can be set appropriately.

The goods preparation-time information is stored in the goods preparation-time information storing section 112b, so as to correspond to a processing apparatus ID that is used for identifying a processing apparatus (such as a cooker) for preparing the same type of goods. The preparation complete-time deriving unit 111b looks up the ordered goods indicated by the received ordered goods information and the ordered goods already stored in the use-information storing unit 112c. Then, the preparation complete-time deriving unit 111b determines whether the ordered goods indicated by the received ordered goods information and the ordered goods stored in the use-information storing unit 112c are to be prepared by the same processing apparatus (step S302). If the processing apparatus is the same, the preparation complete-time deriving unit 111b determines that the condition for the processing apparatus being not be used is met and hence determines that a preparation waiting time is generated (Yes in step S302).

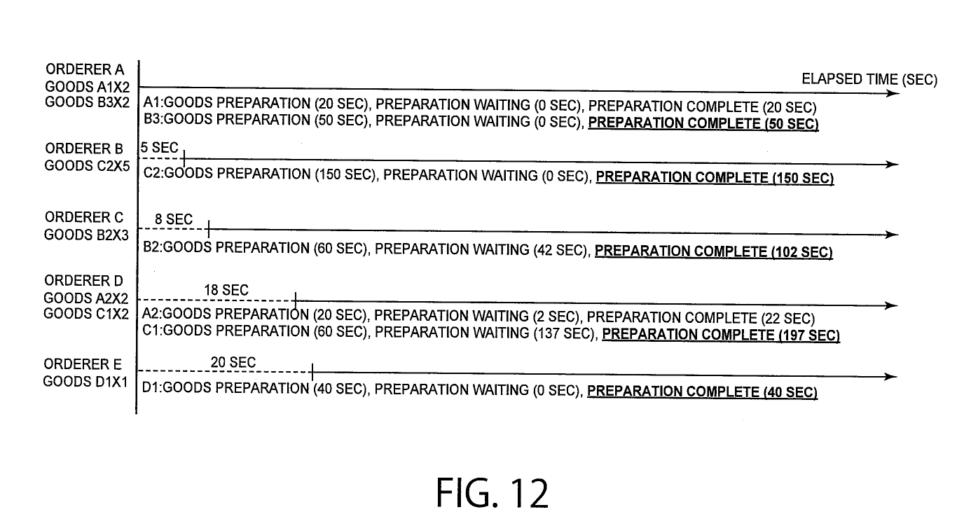

Step S302 is explained in detail with reference to FIG. 12 which shows that an orderer A has placed an order at first after the start of the guidance process, followed by orderers B to E in order. The order of placement by the orderers A to E in FIG. 12 correspond to Nos. 1 to 5 in FIG. 11, respectively.

For the first orderer A, any ordered goods is not stored yet in the use-information storing unit 112c, as ordered goods information. Therefore, there is no processing apparatus that is the same for the ordered goods indicated by the received ordered goods information and the ordered goods stored in the use-information storing unit 112c. In this case, the preparation complete-time deriving unit 111b determines that the condition for a processing apparatus being not be used is not met and hence determines that no preparation waiting time is generated (No in step S302) and moves to step S303.

On the other hand, for the third orderer C, ordered goods B2×3 indicated by the third ordered goods information is the same type as the ordered goods B3×2 indicated by the first ordered goods information for the first orderer A and already stored in the use-information storing unit 112c. Therefore, the processing apparatus is the same for the ordered goods B2 indicated by the received ordered goods information and the ordered goods B3 stored in the use-information storing unit 112c. In this case, the preparation complete-time deriving unit 111b determines that the condition for a processing apparatus being not be used is met and hence determines that a preparation waiting time is generated (Yes in step S302). Then, the preparation complete-time deriving unit 111b moves to step S304 to derive a preparation waiting time based on an elapsed time of the preparation waiting time for the goods B3 ordered earlier. In this case, as shown in FIG. 11, the third ordered goods information is accepted at 12:00:18 that is 8 seconds later than the first ordered goods information accepted at 12:00:10. Therefore, an elapsed time of 8 seconds is subtracted from a goods preparation time of 50 seconds (FIG. 12) for the goods B3×2 for the orderer A to obtain a preparation waiting time of 42 seconds for the goods B2×3 for the orderer C.

If the preparation complete-time deriving unit 111b determines No in step S302 and moves to step S303, it derives a preparation complete time by adding a goods preparation time and a preparation waiting time for each of different goods. Suppose that the goods-menu providing unit 111a receives the fourth ordered goods information that indicates goods A2×2 and C1×2 ordered by the orderer D, as shown in FIG. 12. Moreover, it is supposed that the goods preparation time and preparation waiting time for the goods A2 are 20 seconds and 2 seconds, respectively, and those for the goods C1 are 60 seconds and 137 seconds, respectively, as calculated in the way described above. In this case, the preparation complete time for the goods A2 and C1 are 22 seconds (20+2 seconds) and 197 seconds (60+137 seconds), respectively. The preparation complete-time deriving unit 111b selects the longer preparation complete time (197 seconds in this case) and employs the selected longer preparation complete time as a preparation complete time for ordered goods information.

Then, in step S305, the preparation complete-time deriving unit 111b retrieves the use information that includes the same in-vehicle apparatus ID as the in-vehicle apparatus ID included in the ordered goods information, from among various pieces of use information stored in the use-information storing unit 112c and additionally records the preparation complete time (the selected longer preparation complete time) in the item of preparation complete time included in the retrieved use information. In detail, the preparation complete-time deriving unit 111b determines the order of receive for orderers to receive goods based on the preparation complete times to be stored in the use-information storing unit 112c and each preparation complete time already stored in the storing unit 112c and records the determined order of receive in the item of order of receive in the storing unit 112c. Suppose that, as shown in FIG. 11, the preparation complete-time deriving unit 111b has derived 40 seconds as the preparation complete time that corresponds to the fifth ordered goods information after the start of guidance process and has recorded 30, 135, 90, and 195 seconds as the preparation complete time in the use-information storing unit 112c (that is, the preparation complete-time deriving unit 111b has accepted the placement of order). In this case, the order of receive is the first, the fourth, the third, and the fifth for the goods for which the preparation complete times are 30, 135, 90, 195, and 40 seconds, respectively. The determined order of receive is then recorded in the item of order of receive in the use-information storing unit 112c. The order of receive is changed in accordance with the preparation complete times retrieved one by one.

Then, in step S306, the preparation complete-time deriving unit 111b generates preparation complete-time information that indicates the elapse of the preparation complete times derived in step S305. The preparation complete-time information includes an in-vehicle apparatus ID of each DSRC in-vehicle apparatus 20 and status information (indicating in-preparation or preparation waiting). The preparation complete-time deriving unit 111b controls the DSRC-signal processing section 113 to transmit a preparation complete-time information signal carrying the generated preparation complete-time information from the first DSRC antenna 12a.

The preparation complete-time information signal carrying the preparation complete-time information and transmitted from the first DSRC antenna 12a is received only by the DSRC in-vehicle apparatus 20 having the same in-vehicle apparatus ID as the in-vehicle apparatus ID included in the preparation complete-time information. That is, the DSRC in-vehicle apparatus 20 that has transmitted the ordered-goods information signal receives the preparation complete-time information that includes its own in-vehicle apparatus ID. Then, in the DSRC in-vehicle apparatus 20, the control section 211 controls the display section 215 to display the received preparation complete-time information on its screen. Displayed on the screen of the display section 215 is, for example, the preparation complete time for the completion of preparation of goods ordered by a drive-through user (an orderer) that is counted down as it elapses, as shown in FIG. 13. With this display, a drive-through user can know an approximate time for receiving ordered goods. The display of countdown of the preparation complete time may be done per minute or second. In the case of display per minute, it may be switched to per second when a specific time (for example, one minute) remains. The preparation complete-time information may include sound information for notifying drive-through users of a preparation time. Moreover, the display section 215 may display an ordered goods window so that drive-through users can confirm ordered goods or a CM window for company campaign CM information on the store S, etc. When the steps described above are all performed, the preparation complete-time deriving process ends.

Thereafter, retuning to FIG. 5, the guiding unit 111c keeps watch on the elapse of each preparation complete time derived by the preparation complete-time deriving unit 111b in step S303. When it is determined that any preparation complete time has elapsed or reaches zero (Yes in step S102), the guiding unit 111c generates guide information for guiding a vehicle C1 to a goods delivery window of the store S. The guide information includes the in-vehicle apparatus ID and status information for which a preparation complete time has elapsed in step S102 among the in-vehicle apparatus IDs stored in the use-information storing unit 112c. The status information included in the guide information indicates that the vehicle C1 is guided to the goods delivery window. Then, the guiding unit 111c controls the DSRC-signal processing section 113 to transmit a guide information signal carrying the guide information from the first DSRC antenna 12a (step S109) and performs a guide process (step S110).

The guide process performed by the guiding unit 111c will be explained detail with reference to FIG. 7.

The guide information signal carrying the guide information and transmitted from the first DSRC antenna 12a is received only by the DSRC in-vehicle apparatus 20 having the same in-vehicle apparatus ID as the in-vehicle apparatus ID included in the guide information. That is, the DSRC in-vehicle apparatus 20 that has transmitted the ordered-goods information signal receives the guide information that includes its own in-vehicle apparatus ID. In the DSRC in-vehicle apparatus 20, the control section 211 controls the display section 215 to display the receive guide information on its screen. Displayed on the screen of the display section 215 is information, for example, for guiding a driver (a drive-through user) to the drive-through passage entrance (for example, a layout drawing of the store S and its premises indicating the current location and the location to which a driver is guided). A driver (an orderer) who has confirmed the display moves his or her vehicle C1 that has been parked in the parking space Ps to the drive-through passage entrance.

After transmitting the guide information signal, the guiding unit 111c enters a waiting mode to determine whether a vehicle is detected through the second loop coil 13b embedded in front of the drive-through passage entrance (step S401). When a vehicle C1 moves to the drive-through passage entrance, the second loop coil 13b detects the vehicle C1 and supplies a vehicle detection signal to the store server 11. In response to the vehicle detection signal, the guiding unit 111c generates in-vehicle apparatus ID inquiry information for inquiring an in-vehicle apparatus ID and controls the DSRC-signal processing section 113 to transmit an in-vehicle apparatus ID inquiry information signal carrying the in-vehicle apparatus ID inquiry information from the second DSRC antenna 12b (step S402).

Then, the DSRC in-vehicle apparatus 20 installed in the vehicle C1 now located in front of the drive-through passage entrance receives the in-vehicle apparatus ID inquiry information signal transmitted from the second DSRC antenna 12b. When receiving the in-vehicle apparatus ID inquiry information signal, the DSRC in-vehicle apparatus 20 generates response information that includes its own in-vehicle apparatus ID, under control by the control section 211; and transmits a response information signal carrying the response information to the second DSRC antenna 12b.

The guiding unit 111c then receives the response information carried by response information signal and transmitted from the DSRC in-vehicle apparatus 20. And, the guiding unit 111c extracts the in-vehicle apparatus ID from the response information to determine whether a preparation complete time has elapsed for the same in-vehicle apparatus ID as the extracted ID, among various use information stored in the use-information storing unit 112c, or determine whether the extracted ID matches the in-vehicle apparatus ID included in the supplied guide information (step S403). When it is determined that a preparation complete time for the same in-vehicle apparatus ID as the extracted ID has elapsed (Yes in step S403), the guiding unit 111c controls the gate drive section 115 to open the first gate 14a (step S404). When the first gate 14a is opened, the vehicle C1 to be guided enters the drive-through passage and moves to the goods delivery window located in front of the drive-through passage exit.

When the vehicle C1 moves to the goods delivery window, the guiding unit 111c displays the ordered goods information corresponding to the ordered goods information stored in the use-information storing unit 112c on the screen of a communications apparatus (not shown) installed in the goods delivery window so that a store clerk can prepare the delivery of ordered goods to an orderer.

On the other hand, when it is determined that a preparation complete time for the same in-vehicle apparatus ID as the extracted ID has not elapsed, or the extracted ID does not match the in-vehicle apparatus ID included in the guide information (No in step S403), the guiding unit 111c do not open the first gate 14a and generates an NG screen information for notifying of no guide in step S405. The NG screen information is sent to the display section 215 of the DSRC in-vehicle apparatus 20 that has transmitted the response information signal. Then, the display section 215 of the DSRC in-vehicle apparatus 20 displays a message on its screen, such as “Let us guide you when the preparation complete time elapses. Please wait in the parking space Ps for a while”.

After opening the first gate 14a (step S404), the guiding unit 111c enters a waiting mode to determine whether a vehicle is detected through the third loop coil 13c embedded in front of the drive-through passage exit (step S406). When the vehicle C1 moves to the drive-through passage exit, the third loop coil 13c detects the vehicle C1 and supplies a vehicle detection signal to the store server 11. In response to the vehicle detection signal, the guiding unit 111c generates a payment inquiry information for inquiring an in-vehicle apparatus ID and a payment card ID of a DSRC payment card 30 (FIG. 4) and controls the DSRC-signal processing section 113 to transmit a payment inquiry information signal carrying the payment inquiry information from the third DSRC antenna 12c (step S407).

Then, the DSRC in-vehicle apparatus 20 installed in the vehicle C1 now located in front of the drive-through passage exit receives the payment inquiry information signal transmitted from the third DSRC antenna 12c. When receiving the payment inquiry information signal, the DSRC in-vehicle apparatus 20 generates response payment information that includes its own in-vehicle apparatus ID and the payment card ID of the DSRC payment card 30, under control by the control section 211, and transmits a response payment information signal carrying the response payment information to the third DSRC antenna 12c.

The guiding unit 111c then receives the response payment information carried by response payment information signal and transmitted from the DSRC in-vehicle apparatus 20. And, the guiding unit 111c extracts the item of ordered goods for the in-vehicle apparatus ID included in the response payment information and displays the extracted item of ordered goods on the screen of the communications apparatus (not shown) installed in the goods delivery window, thereby a store clerk delivering the ordered goods to an orderer of the vehicle C1.

Next, the guiding unit 111c determines whether the received response payment information includes a payment ID (step S408). When it is determined that the received response payment information includes the payment ID (Yes step S408), the guiding unit 111c performs a money payment process for the ordered goods using the payment ID (step S409).

Then, the guiding unit 111c controls the gate drive section 115 to automatically open the second gate 14b (step S410) to smoothly guide the vehicle C1 to the outside through the drive-through passage.

On the other hand, when it is determined that the received response payment information does not include the payment ID (No step S408), the guiding unit 111c cannot perform a money payment process for the ordered goods using the payment ID. In this case, the guiding unit 111c generates an NG screen information for notifying of no payment in step S411. The NG screen information is sent to the display section 215 of the DSRC in-vehicle apparatus 20 that has transmitted the response payment information signal. Then, the display section 215 of the DSRC in-vehicle apparatus 20 displays a message on its screen, such as “Card authentication failed”. In this case, an orderer of the vehicle C1 pays cash for the ordered goods. Thereafter, a store clerk operates an actuator (not shown) to open the second gate 14b so that the vehicle C1 exits through the drive-through passage. Then, the guide process ends.

Returning to FIG. 5, after the guide process of step S110, the guiding unit 111c erases the use information having the in-vehicle apparatus ID used for the money payment from the use-information storing unit 112c (step S111). However, when the money payment is not automatically performed in the guide process of step S110, a store clerk erases the use information having the in-vehicle apparatus ID from the use-information storing unit 112c by operating a communications apparatus. Thereafter, until the goods-menu providing unit 111a determines that all waiting processes have been running out of time (time out) among the various processes executed by the guidance process program in step S101, the guidance apparatus 10 repeatedly performs the process from steps S101 to S111 with the DSRC in-vehicle apparatus 20 installed in each of several vehicles C1 parked in the parking lot Pa of the store S. Then, the guidance apparatus 10 guides a driver (drive-through user, or an orderer) of each vehicle C1 to the goods delivery window in accordance with the order of elapse of the derived preparation complete time. If the goods-menu providing unit 111a determines that all waiting processes have been running out of time (time out) among the various processes executed by the guidance process program (Yes in step S101), the guidance process ends. Accordingly, the store server 11 (the guidance apparatus 10) finishes the guidance process in accordance with the guidance program.

As described above in detail, according to the guidance apparatus 10 and the guidance system 1 of the present embodiment, a vehicle of a user can be efficiently guided until he or she receives ordered goods in a drive-through store. Therefore, the utility value of a DSRC payment system can be enhanced by implementing the guidance apparatus 10 and the guidance system 1 of the present embodiment.

In the guidance system in the present embodiment, an orderer himself or herself selects and determines goods for order placement by using the DSRC in-vehicle apparatus 20. However, the communications apparatus employed in the guidance system according to the present invention can be used no only by an orderer himself or herself but also by a person or a store clerk who receives order placement. For example, although the guidance system 1 is used only by an orderer of a vehicle C1 equipped with the DSRC in-vehicle apparatus 20 in the present embodiment, the guidance system 1 can be employed with a conventional drive-through system.

An example of co-use of the guidance system 1 and a conventional drive-through system will be described hereinbelow.

Suppose that, as shown in FIG. 2, a vehicle C2 that is not equipped with the DSRC in-vehicle apparatus 20 enters the drive-through passage entrance of the store S, in the same way as a conventional drive-through system. Provided at the drive-through passage entrance is an order window, installed with a communications apparatus (not shown) used by a store clerk for accepting an order placement by an orderer. Embedded near the order window is the fourth loop coil 13d to detect an entering vehicle.

When the fourth loop coil 13d detects the vehicle C2, it supplies a vehicle detection signal to the store server 11, in the same way as described above. In response to the vehicle detection signal, the store server 11 transmits a signal carrying notification information on the entrance of the vehicle C2 to the communications apparatus of the store clerk for accepting order placement. Then, the communications apparatus displays the information on the entrance of the vehicle C2 on its screen. The store clerk accepts an order placement for goods by an orderer of the vehicle C2 and transmits an ordered-goods information signal carrying ordered goods information from the communications apparatus to the store server 11.

When receiving the ordered-goods information signal carrying ordered goods information from the communications apparatus, the store server 11 (the preparation complete-time deriving unit 111b) generates use information based on the ordered goods information, in the same way as described above, and stores the use information in the use-information storing unit 112c. Since, the vehicle C2 is not equipped with the DSRC in-vehicle apparatus 20, the generated use information does not include an in-vehicle apparatus ID. The store server 11 (the preparation complete-time deriving unit 111b) transmits the use information stored in the use-information storing unit 112c to the communications apparatus of the store clerk who has accepted order placement. The communications apparatus displays the use information on its screen to notify the store clerk of the use information. Then, the store clerk outputs a use information sheet, printed on which is the use information (including the ordered goods, order receive time, preparation complete time, etc.) from the communications apparatus and passes it to the orderer.

Thereafter, the store server 11 (the guiding unit 111c) transmits a signal that carries an order number of the use information for which a preparation complete time stored in the use-information storing unit 112c has elapsed, to the communications apparatus of the store clerk who has accepted order placement. When receiving the signal from the server 11, the communications apparatus displays the order number on its screen. Then, the store clerk operates an actuator (not shown) to open the third gate 14c to guide the vehicle C2 corresponding to the order number. The display of the order number is also performed by the communications apparatus installed at the goods delivery window. Accordingly, a store clerk for goods delivery prepares the delivery. When the third gate 14c is opened, the orderer of the vehicle C2 moves to the delivery window to pass the use information sheet he or she has received at the order window to the store clerk for goods delivery. Then, the store clerk inputs the order number printed on the use information sheet to the communications apparatus to confirm the ordered goods information sent from the server 11 and corresponding to the order number. Then, the store clerk passes the ordered goods to the orderer and receives money for that to perform money payment. And, the store clerk operates an actuator (not shown) to open the second gate 14b to guide the vehicle C2 to exit from the drive-through passage. Then, the store clerk uses the communications apparatus to erase the use information corresponding to the order number for which money payment has been performed, from the corresponding use information stored in the use-information storing unit 112c of the server 11.

As described above, the guidance apparatus according to the present invention can be employed with a conventional drive-through system.

Moreover, in the embodiment described above, the goods preparation-time information indicates the correspondence between goods and a preparation time for the goods. The preparation complete-time deriving unit 111b uses this goods preparation-time information to multiply a preparation time for the ordered goods by the number of the ordered goods to calculate a goods preparation time. Not only that, the goods preparation-time information may indicate the correspondence between ordered goods and a preparation time for the ordered goods, depending on the number of the ordered goods, thereby acquiring a goods preparation time for the number of the ordered goods.

Moreover, suppose that there are two or more of preparation complete times each derived by the preparation complete-time deriving unit 111b for received ordered goods information, that will elapse almost at the same timing (for example, including 5-second time difference). In this case, the guide information depending on the elapse of the preparation complete times may be notified at a timing different from the order of placement of order. In this case, the notification timing of the guide information may be varied for a former orderer and a latter orderer so that the guide information is notified first to the former or the latter orderer with a longer time difference (for example, 15-second time difference) than the time difference mentioned above.

Furthermore, after starting the guidance process, the store server 11 may transmit the initial-screen information signal from the first DSRC antenna 110a whenever it determines that it has received a vehicle detection signal from the first loop coil 13a.

Furthermore, the preparation complete-time deriving unit 111b of the store server 11 may accept a new order from an orderer or the cancellation of order placement already made by the orderer during the period from the reception of ordered goods information from the orderer to the generation of guide information at the guiding unit 111c. In detail, when an orderer has placed an order, an elapsed time of a preparation complete time derived by the preparation complete-time deriving unit 111b is displayed on the screen of the display unit 215 of the DSRC in-vehicle apparatus 20. With this elapsed time, a selection window (or item) may be displayed on the screen of the display unit 215 so that he or she can cancel the order placement already made or place an additional order.

For example, suppose that an orderer performs the selection of placing an additional order through the input section 214. In this case, the DSRC in-vehicle apparatus 20 communicates with the store server 11, with the transmission of its own in-vehicle apparatus ID, via the first DSRC antenna 12a. Then, the DSRC in-vehicle apparatus 20 receives goods menu information on goods sold at the store S and ordered goods information on goods ordered by the orderer, and displays the goods menu information and the ordered goods information on the display section 215. Then, the orderer confirms the goods menu information and the ordered goods information on the display section 215 and selects and determines the goods for additional order placement via the input section 214. The DSRC in-vehicle apparatus 20 generates additional-ordered goods information on the goods for which the orderer has placed an additional order and transmits this information to the server 11, together with its own in-vehicle apparatus ID, via the first DSRC antenna 12a.

When receiving the additional-ordered goods information on the goods for which the orderer has placed an additional order, the preparation complete-time deriving unit 111b of the store server 11 derives a preparation complete time for the goods for which the orderer has placed an additional order, in the same way as the embodiment. With the derivation of the preparation complete time, the preparation complete-time deriving unit 111b generates new use information including the items of in-vehicle apparatus ID, order number, ordered goods, status (use status), order receive time, preparation complete time, order of receive, etc. and additionally stores the new use information in the use-information storing unit 112c.

When deriving a preparation complete time corresponding to the additional ordered goods information, the preparation complete-time deriving unit 111b retrieves an elapsed time (the remaining time) of a prier preparation complete time corresponding to the ordered goods information received prier to the additional ordered goods information, from the use-information storing unit 112c. The prier ordered goods information and the additional ordered goods information include the same in-vehicle apparatus ID. Then, the preparation complete-time deriving unit 111b compares the elapsed time (the remaining time) of the prier preparation complete time and the preparation complete time derived for the additional order. Suppose that the elapsed time (the remaining time) of the prier preparation complete time is earlier than the preparation complete time derived for the additional order (the preparation of the goods ordered earlier is completed first). In this case, the preparation complete-time deriving unit 111b controls the DSRC-signal processing section 13 to transmit preparation complete-time information that indicates the status of elapse of the preparation complete time together with the in-vehicle apparatus ID mentioned above to the DSRC in-vehicle apparatus 20 of the orderer for the additional order placement, via the first DSRC antenna 12a. Accordingly, displayed on the display section 215 of the DSRC in-vehicle apparatus 20 is not the elapsed time (the remaining time) of the prier preparation complete time but the preparation complete time derived for the additional order. On the other hand, suppose that the elapsed time (the remaining time) of the prier preparation complete time is not earlier than the preparation complete time derived for the additional order (the preparation of the goods ordered earlier is completed later). In this case, the preparation complete-time deriving unit 111b does not need to perform the transmission control described above.

Next, suppose that an orderer performs the selection of cancellation of order placement. In this case, the DSRC in-vehicle apparatus 20 communicates with the store server 11, with the transmission of its own in-vehicle apparatus ID, via the first DSRC antenna 12a. Then, the DSRC in-vehicle apparatus 20 receives goods information on goods that has been ordered by the orderer and displays the goods information on the display section 215. Then, the orderer confirms the goods information on the display section 215 and selects and determines the goods for cancellation via the input section 214. The DSRC in-vehicle apparatus 20 generates order cancellation information on the goods for which an order is cancelled and transmits this information to the server 11, together with its own in-vehicle apparatus ID, via the first DSRC antenna 12a.

When receiving the order cancellation information, the preparation complete-time deriving unit 111b of the store server 11 accepts the cancellation of order by the orderer. In response to the cancellation of order, the complete-time deriving unit 111b erases or modifies the use information stored in the use-information storing unit 112c.

In detail, the preparation complete-time deriving unit 111b retrieves use information including the in-vehicle apparatus ID identical to the in-vehicle apparatus ID included in the received order cancellation information, from the use-information storing unit 112c. Then, the preparation complete-time deriving unit 111b erases the ordered goods corresponding to the cancelled order from among the ordered goods included in the retrieved use information and records the goods remaining after the erasure to the item of ordered goods.

Suppose that there is no goods remaining after the erasure due to the order cancellation. In this case, the preparation complete-time deriving unit 111b eases the use information having the item of the ordered goods from the use-information storing unit 112c. Moreover, suppose that a preparation complete time included in the use information has been derived from the goods preparation time for the goods for which an order is cancelled. In this case, the preparation complete-time deriving unit 111b selects the longest preparation complete time from among the preparation complete times derived for the remaining goods after the erasure. And then, the preparation complete-time deriving unit 111b subtracts an elapsed time from an order acceptance time included in the use information from the selected longest preparation complete time and updates the item of preparation complete time in the use information with the remaining time after the subtraction (stores the remaining time in the use-information storing unit 112c).

Furthermore, suppose that, due to the cancellation of order for goods, the processing apparatus for the preparation of the goods is available for other goods so that a preparation waiting time is shortened for goods the same type as the goods for which an order is cancelled and ordered after the goods for which an order is cancelled, and also a preparation complete time included in each use information is shortened. In this case, the preparation complete-time deriving unit 111b derives again a preparation complete time for each goods included in each use information. Then, the preparation complete-time deriving unit 111b selects the longest preparation complete time from among the preparation complete times derived again. And then, the preparation complete-time deriving unit 111b subtracts an elapsed time from an order acceptance time included in the use information from the selected longest preparation complete time and updates the item of preparation complete time in the use information with the remaining time after the subtraction (stores the remaining time in the use-information storing unit 112c).

Thereafter, the preparation complete-time deriving unit 111b generates preparation complete-time information including an in-vehicle apparatus ID included in the use information for which the item of preparation complete time has been updated in the use-information storing unit 112c. And, in the same way as the embodiment, the preparation complete-time deriving unit 111b controls the DSRC-signal processing section 113 to transmit the generated preparation complete-time information to the DSRC in-vehicle apparatus 20 having the in-vehicle apparatus ID identical to the in-vehicle apparatus ID included in the updated use information, via the first DSRC antenna 12a. Accordingly, displayed on the screen of the display section 215 of the DSRC in-vehicle apparatus 20 is an elapsed time (the remaining time) of the preparation complete time that has been updated (shortened) due to the cancellation of order.

Described above is the application of the present invention to a drive-through system as the embodiment and variations. Not only that, the present invention is applicable to a guidance system for guiding an orderer when he or she places an order for goods and the preparation of the goods is completed, in a food court such as a large supermarket and a restaurant at a service area of a highway, for efficiently guiding a user from the order placement to the delivery of ordered goods.

The guidance program executed in the embodiment described above may be stored in a portable storage medium such as CD-ROM (Compact Disk Read Only Memory). Moreover, the guidance program may be installed in the guidance apparatus 10 from such a portable storage medium via a reader. Furthermore, the guidance program may be downloaded via the Internet or the like and installed in the guidance apparatus 10. Still furthermore, the guidance program may be stored in a storage apparatus such as a server that can communicate with the guidance apparatus 10 so that the guidance apparatus 10 can communicate with the storage apparatus to perform the guidance process.

The present invention may not be limited to the embodiment and the attached drawings and hence various changes and modifications may be made in the invention without departing from the sprit and scope thereof.

As described above in detail, the present invention provides a guidance apparatus, a guidance method, and a guidance program for efficiently guiding a user from the order placement for goods to the delivery of goods.

What is claimed is:

1. A guidance apparatus comprising:
a goods preparation-time information storing unit configured to store goods preparation-time information that indicates goods for which an orderer has placed an order and a preparation time required for preparing the goods;
a preparation complete-time deriving unit configured to derive a preparation complete time required for completing the preparation of the goods by using the stored goods preparation-time information and using ordered goods information indicating the goods when the preparation complete-time deriving unit receives the ordered goods information based on the order placement by the orderer; and
a guiding unit configured to generate guide information for guiding the orderer based on the derived preparation complete time.

2. The guidance apparatus according to claim 1, wherein the goods preparation-time information storing unit stores a plurality of pieces of goods preparation-time information indicating a plurality of goods for which orderers have placed an order, respectively, and preparation times required for preparing the plurality of goods, respectively,
the preparation complete-time deriving unit derives the preparation complete time whenever receiving the ordered goods information based on order placement by any one of the orderers, and
the guiding unit generates the guide information for goods ordered by an order and for which a preparation complete time elapses before another preparation complete time for goods ordered by another order.

3. The guidance apparatus according to claim 1, wherein the preparation complete-time deriving unit generates preparation complete-time information that indicates elapse of the preparation complete time.

4. The guidance apparatus according to claim 1, wherein the goods preparation-time information storing unit stores a plurality of pieces of goods preparation-time information indicating a plurality of different types of goods for which orderers have placed an order, respectively, and preparation times required for preparing the plurality of different types of goods, respectively,
the preparation complete-time deriving unit derives preparation complete times for the different types of goods, and selects the longest preparation complete time among the different types of goods, and
the guiding unit generates the guide information based on the selected longest preparation complete time.

5. The guidance apparatus according to claim 1, wherein the preparation complete-time deriving unit derives a goods preparation waiting time when a pre-stored condition is met for the goods preparation waiting time to be generated for the ordered goods indicated by the ordered goods information and for which the preparation takes time, and adds a time obtained by subtracting an elapse time from the goods preparation waiting time to the preparation time, thus deriving the preparation complete time.

6. The guidance apparatus according to claim 1, wherein the guiding unit generates the guide information depending on elapse of the preparation complete time.

7. The guidance apparatus according to claim 1, wherein the goods preparation-time information storing unit stores a plurality of pieces of goods preparation-time information indicating a plurality of goods for which orderers have placed an order, respectively, and preparation times required for preparing the plurality of goods, respectively, the apparatus further comprising a first communications unit installed along a passage to a goods delivery window for the orderers to receive the goods, for communication with a second communications unit of each orderer,
wherein the first communications unit receives identification information that identifies each orderer from the second communications unit, and
after generating the guide information, the guiding unit identifies, based on the identification information, the orderers to be guided in accordance with the guide information and guides the orderers in order of earlier communication between the first and second communications unit.

8. A guidance method comprising the steps of:
storing goods preparation-time information that indicates goods for which an orderer has placed an order and a preparation time required for preparing the goods;
deriving a preparation complete time required for completing the preparation of the goods by using the stored goods preparation-time information and using ordered goods information indicating the goods when the ordered goods information is received based on the order placement by the orderer; and
generating guide information for guiding the orderer based on the derived preparation complete time.

9. The guidance method according to claim 8, wherein the storing step generates a plurality of pieces of goods preparation-time information indicating a plurality of goods for which orderers have placed an order, respectively, and preparation times required for preparing the plurality of goods, respectively,
the preparation complete time is derived whenever the ordered goods information is received based on order placement by any one of the orderers, and
the guide information is generated for goods ordered by an order and for which a preparation complete time elapses before another preparation complete time for goods ordered by another order.

10. The guidance method according to claim 8, wherein the deriving step generates preparation complete-time information that indicates elapse of the preparation complete time.

11. The guidance method according to claim 8, wherein the storing step stores a plurality of pieces of goods preparation-time information indicating a plurality of different types of goods for which orderers have placed an order, respectively, and preparation times required for preparing the plurality of different types of goods, respectively,
preparation complete times are derived for the different types of goods, and the longest preparation complete time is selected among the different types of goods, and
the guide information is generated based on the selected longest preparation complete time.

12. The guidance method according to claim 8, wherein the deriving step derives a goods preparation waiting time when a pre-stored condition is met for the goods preparation waiting time to be generated for the ordered goods indicated by the ordered goods information and for which the preparation takes time, and adds a time obtained by subtracting an elapse time from the goods preparation waiting time to the preparation time, thus deriving the preparation complete time.

13. The guidance method according to claim 8, wherein the guide information is generated depending on elapse of the preparation complete time.

14. The guidance method according to claim 8, wherein the storing step stores a plurality of pieces of goods preparation-time information indicating a plurality of goods for which orderers have placed an order, respectively, and preparation times required for preparing the plurality of goods, respectively,
the method further comprising the step of communication between a first communications unit installed along a passage to a goods delivery window for the orderers to receive the goods and a second communications unit of each orderer,
wherein identification information that identifies each orderer is transmitted from the second communications unit to the first communications unit,
after the guide information is generated, the orderers guided in accordance with the guide information are identified based on the identification information, and
the orderers are guided in order of earlier communication between the first and second communications unit.

15. A guidance program stored in a non-transitory computer readable device comprising:
a program code of storing goods preparation-time information that indicates goods for which an orderer has placed an order and a preparation time required for preparing the goods;
a program code of deriving a preparation complete time required for completing the preparation of the goods by using the stored goods preparation-time information and using ordered goods information indicating the goods when the ordered goods information is received based on the order placement by the orderer; and
a program code of generating guide information for guiding the orderer based on the derived preparation complete time.

16. The guidance program according to claim 15, wherein the storing program code generates a plurality of pieces of goods preparation-time information indicating a plurality of goods for which orderers have placed an order, respectively, and preparation times required for preparing the plurality of goods, respectively,
the preparation complete time is derived whenever the ordered goods information is received based on order placement by any one of the orderers, and
the guide information is generated for goods ordered by an order and for which a preparation complete time elapses before another preparation complete time for goods ordered by another order.

17. The guidance program according to claim 15, wherein the storing program code stores a plurality of pieces of goods preparation-time information indicating a plurality of different types of goods for which orderers have placed an order, respectively, and preparation times required for preparing the plurality of different types of goods, respectively,
preparation complete times are derived for the different types of goods, and the longest preparation complete time is selected among the different types of goods, and
the guide information is generated based on the selected longest preparation complete time.

18. The guidance program according to claim 15, wherein the deriving program code derives a goods preparation waiting time when a pre-stored condition is met for the goods preparation waiting time to be generated for the ordered goods indicated by the ordered goods information and for which the preparation takes time, and adds a time obtained by subtracting an elapse time from the goods preparation waiting time to the preparation time, thus deriving the preparation complete time.

19. The guidance program according to claim 15, wherein the guide information is generated depending on elapse of the preparation complete time.

20. The guidance program according to claim 15, wherein the storing program code stores a plurality of pieces of goods preparation-time information indicating a plurality of goods for which orderers have placed an order, respectively, and preparation times required for preparing the plurality of goods, respectively,
the program further comprising the program code of communication between a first communications unit installed along a passage to a goods delivery window for the orderers to receive the goods and a second communications unit of each orderer,
wherein identification information that identifies each orderer is transmitted from the second communications unit to the first communications unit,
after the guide information is generated, the orderers guided in accordance with the guide information are identified based on the identification information, and
the orderers are guided in order of earlier communication between the first and second communications unit.
